(19) United States
(12) Patent Application Publication
(10) Pub. No.: US 2014/0176471 A1
(43) Pub. Date: Jun. 26, 2014

(54) TOUCH-SENSITIVE ELECTRONIC DEVICE AND METHOD FOR CONTROLLING APPLICATIONS USING EXTERNAL KEYPAD

(71) Applicant: CHIUN MAI COMMUNICATION SYSTEMS, INC., New Taipei (TW)

(72) Inventor: FU-YUAN HSIEH, New Taipei (TW)

(73) Assignee: CHIUN MAI COMMUNICATION SYSTEMS, INC., New Taipei (TW)

(21) Appl. No.: 14/135,401

(22) Filed: Dec. 19, 2013

(30) Foreign Application Priority Data
Dec. 24, 2012 (TW) 101149464

(51) Int. Cl. G06F 3/041

(52) U.S. Cl. CPC G06F 3/041
USPC 345/173

(57) ABSTRACT

For a touch-sensitive electronic device with a touch screen, a method allows user operations on a connected peripheral input device such as an external keypad to be mapped to, and activate, keys displayed or inbuilt on the electronic device. Each key of the external keypad is initialized when the external keypad is connected to the electronic device. The user selects an application to be controlled and a coordinate position for each displayed or inbuilt key is associated with the keys of the external keypad. The electronic device receives a sensing signal when a key of the external keypad is pressed, determines a coordinate position of the associated key on the touch screen, and executes an operation of the application accordingly.

### BACKGROUND

1. Technical Field

Embodiments of the present disclosure relate to external peripheral device management systems and methods, and particularly to a touch-sensitive electronic device and method for controlling applications of the touch-sensitive electronic device using external keypads.

2. Description of Related Art

Touch-sensitive screens are known for use with portable electronic devices including handheld cell phones, music players, video players, and the like. In these portable electronic devices, a touch-sensitive screen includes a displayed touch keypad and sensors to detect a touch, and electronic circuitry or programs are used to associate that touched portion with a key on the touch keypad. However, since the touch keypad is typically small, it is difficult to precisely strike a given key on the touch keypad, and it is frequently necessary to visually inspect the touch keypad to make sure the correct keys are actuated. In this case, even a slight mis-strike on the touch keypad may result in an erroneous key entry. Accordingly, there is a need to provide external keypads connected to the electronic devices easier to use and with greater accuracy.

### BRIEF DESCRIPTION OF THE DRAWINGS

FIG. 1 is a block diagram of one embodiment of a touch-sensitive electronic device including a keypad controlling system.

FIG. 2A and FIG. 2B show diagrams illustrating embodiments of the touch-sensitive electronic device connected to one or more external keypads.

FIG. 3 is a block diagram illustrating function modules of the keypad controlling system included in the touch-sensitive electronic device.

FIG. 4 shows a diagram illustrating setting of a coordinate position for each key of a keypad on the touch screen.

FIG. 5 is a flowchart of one embodiment of a method for controlling applications using an external keypad connected to the touch-sensitive electronic device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

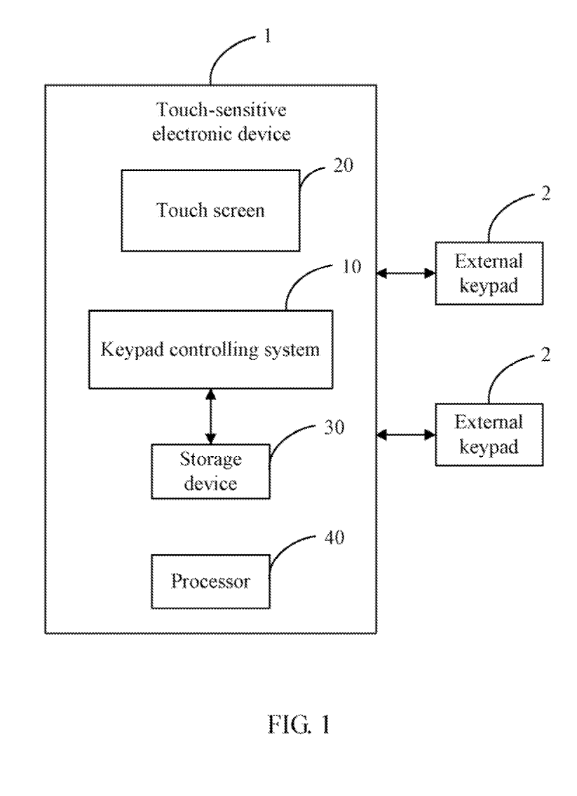

FIG. 1 is a block diagram of one embodiment of a touch-sensitive electronic device 1 including a keypad controlling system 10. In the embodiment, the touch-sensitive electronic device 1 may further include, but is not limited to, a touch screen 20, a storage device 30, and at least one processor 40. In the embodiment, the keypad controlling system 10 may include computerized instructions in the form of one or more programs that are stored in the storage device 30 and executed by the at least one processor 40. The touch-sensitive electronic device 1 may be a tablet computer, a handheld cell phone, a music player, a video player, a personal digital assistant (PDA), or the like. FIG. 1 illustrates only one example of the touch-sensitive electronic device 1, other examples may include more or fewer components than illustrated, or have a different configuration of the various components in other embodiments.

The touch screen 20 displays a touch pad provided for a user to input information and commands. In one embodiment, the storage device 30 may be an internal storage system, such as a random access memory (RAM) for temporary storage of information, and/or a read only memory (ROM) for permanent storage of information. The storage device 30 may also be an external storage system, such as an external hard disk, a storage card, or a data storage medium. The at least one processor 40 is a central processing unit (CPU), a microprocessor, or data processor that performs various functions of the touch-sensitive electronic device 1.

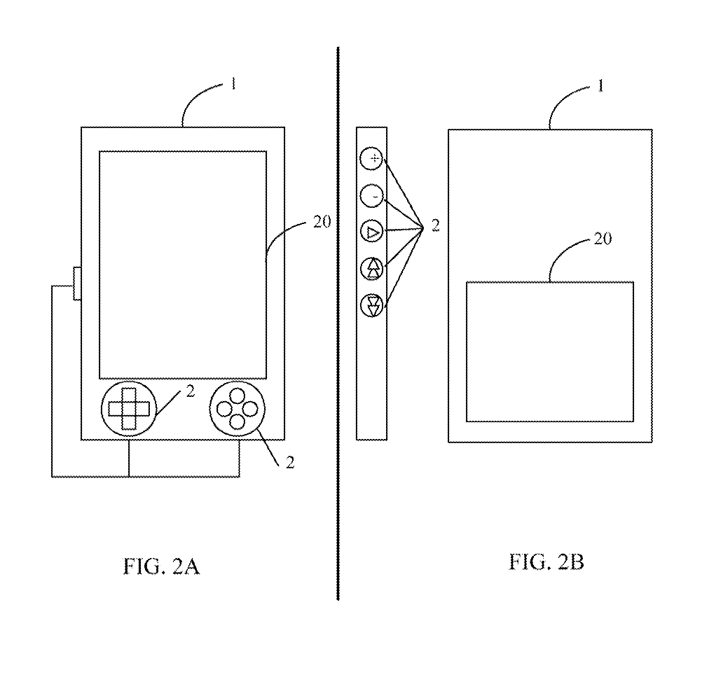

FIG. 2A and FIG. 2B show one embodiment of the touch-sensitive electronic device 1 connected to one or more external keypads 2. In the embodiment, the one or more external keypads 2 are connected to the touch-sensitive electronic device 1. Each of the external keypads 2 include a plurality of keys and sensors to detect which key is pressed. The keys may include numerical keys, alphabetical keys, directional keys, functional keys, and the like. Referring to FIG. 2A, each of the external keypads 2 is connected to the touch-sensitive electronic device 1 through a universal serial bus (USB) interface. Referring to FIG. 2B, each of the external keypads 2 is connected to the touch-sensitive electronic device 1 in a wireless connection, such as a WIFI connection and a BLUETOOTH connection.

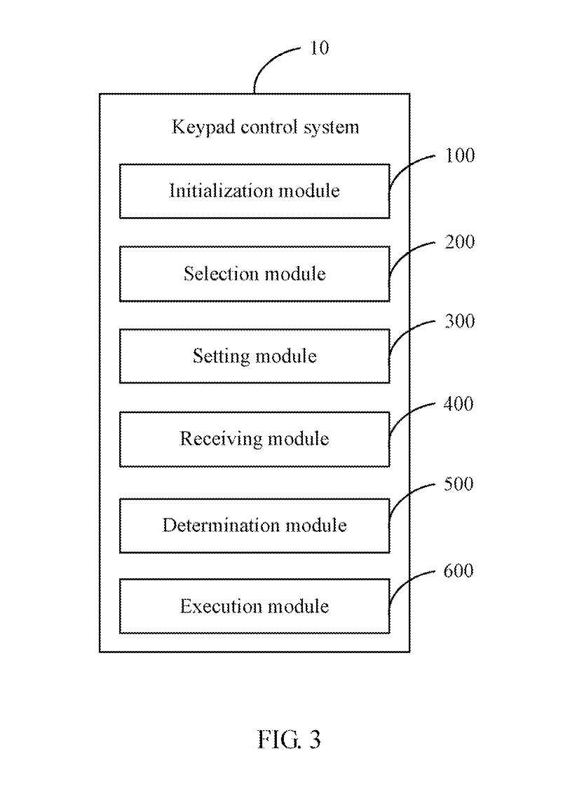

FIG. 3 is a block diagram illustrating function modules of the keypad controlling system 10 included in the touch-sensitive electronic device 1. In one embodiment, the keypad controlling system 10 may include an initialization module 100, a selection module 200, a setting module 300, a receiving module 400, a determination module 500, and an execution module 600. The modules 100-600 may comprise computerized instructions in the form of one or more computer-readable programs that are stored in a non-transitory computer-readable medium (such as the storage device 30) and executed by the at least one processor 40.

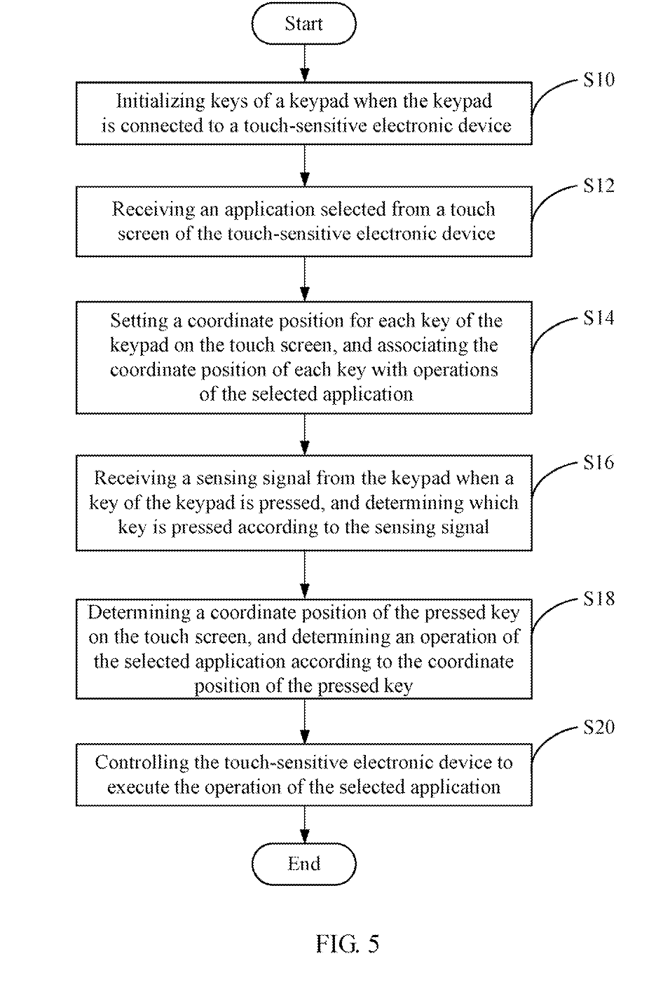

FIG. 5 is a flowchart of one embodiment of a method for controlling applications using an external keypad 2 connected to the touch-sensitive electronic device 1. Depending on the embodiment, additional steps may be added, others removed, and the ordering of the steps may be changed.

In step S10, the initialization module 100 initializes keys of each of the external keypads 2 when the external keypad 2 is connected to the touch-sensitive electronic device 1.

In step S12, the selection module 200 displays one or more applications on the touch screen 20, and receives a selection of an application from the one or more applications displayed on the touch screen 20. In the embodiment, the selected application can be controlled by the external keypad 2 when the user operates the external keypad 2.

In step S14, the setting module 300 sets a coordinate position for each key of the external keypad 2 on the touch screen 20, and associates the coordinate position of each key with operations of the selected application. In the embodiment, the setting module 300 establishes an X-Y coordinate system based on the width and length of the touch screen 20, sets a coordinate position for each keys of the external keypad 2 based on the X-Y coordinate system, and associates each key of the external keypad 2 with the selected application according to the coordinate positions.

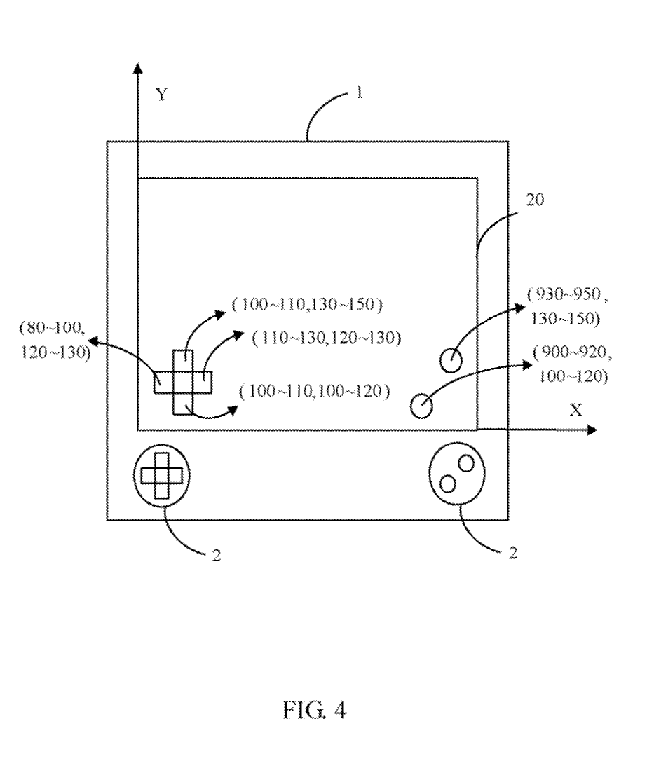

FIG. 4 shows a diagram illustrating setting of coordinate position for each key of the external keypad 2 on the touch screen 20. If the selected application is a game application which is operated by four directional keys and two functional keys, the coordinate position of each key is set to control the game application. The directional keys include an upward-arrow key, a downward-arrow key, a leftward-arrow key, and a rightward-arrow key, and the functional key includes an accelerator key, and a volume control key. The coordinate position of the upward-arrow key is set as a coordinate range (100˜110, 130˜150), the coordinate position of the downward-arrow key is set as a coordinate range (100˜110, 100˜120), the coordinate position of the leftward-arrow key is set as a coordinate range (80˜100, 120˜130), and the coordinate position of the rightward-arrow key is set as a coordinate range (110—130, 120˜130). The coordinate position of the accelerator key is set as a coordinate range (900˜920, 100˜120), and the coordinate position of the volume control key is set as a coordinate range (930˜950, 130˜150).

In step S16, the receiving module 400 receives a sensing signal from the external keypad 2 when a key of the external keypad 2 is pressed, and determines which key is pressed according to the sensing signal.

In step S18, the determination module 500 determines a coordinate position of the pressed key on the touch screen 20, and determines an operation of the selected application according to the coordinate position of the pressed key. For example, the coordinate range (80˜100, 120˜130) of the touch screen 20 is determined to have been activated when the leftward-arrow key of the external keypad 2 is pressed, and the determination module 500 determines a leftward-move operation for the game application.

In step S20, the execution module 600 controls the touch-sensitive electronic device 1 to execute the operation of the selected application. For example, the leftward-move operation of the game application is executed when the user presses the leftward-arrow key of the external keypad 2.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A touch-sensitive electronic device, comprising:
a touch screen and at least one processor;
a storage device storing a computer-readable program including instructions that, when executed by the at least one processor, causes the at least one processor to:
initialize keys of an external keypad when the external keypad is connected to the touch-sensitive electronic device;
receive a selection of an application to be controlled by the external keypad from one or more applications displayed on a touch screen of the touch-sensitive electronic device;
set a coordinate position for each key of the external keypad on the touch screen, and associate the coordinate positions of the keys with operations of the selected application;
receive a sensing signal from the external keypad when a key of the external keypad is pressed, and determine which key is pressed according to the sensing signal;
determine a coordinate position of the pressed key on the touch screen, and determine an operation of the selected application according to the coordinate position of the pressed key; and
control the touch-sensitive electronic device to execute the operation of the selected application.

2. The touch-sensitive electronic device according to claim 1, wherein the external keypad comprises a plurality of keys and sensors to detect which key is pressed.

3. The touch-sensitive electronic device according to claim 2, wherein the keys comprise numerical keys, alphabetical keys, directional keys, and functional keys.

4. The touch-sensitive electronic device according to claim 3, wherein the directional keys comprises an upward-arrow key, a downward-arrow key, a leftward-arrow key, and a rightward-arrow key, and the functional keys comprises an accelerator key and a volume control key.

5. The touch-sensitive electronic device according to claim 1, wherein the external keypad is connected to the touch-sensitive electronic device through a universal serial bus (USB) interface or a wireless connection including a WIFI connection and a Bluetooth connection.

6. The touch-sensitive electronic device according to claim 1, wherein the coordinate position of each keys of the external keypad on the touch screen is set by establishing an X-Y coordinate system based on a width and length of the touch screen, and by defining the coordinate position for each key of the external keypad based on the X-Y coordinate system.

7. A method for controlling applications using an external keypad connected to a touch-sensitive electronic device, the method comprising:
initializing keys of the external keypad when the external keypad is connected to the touch-sensitive electronic device;
receiving a selection of an application to be controlled by the external keypad from one or more applications displayed on a touch screen of the touch-sensitive electronic device;
setting a coordinate position for each key of the external keypad on the touch screen, and associating the coordinate positions of the keys with operations of the selected application;
receiving a sensing signal from the external keypad when a key of the external keypad is pressed, and determining which key is pressed according to the sensing signal;
determining a coordinate position of the pressed key on the touch screen, and determining an operation of the selected application according to the coordinate position of the pressed key; and
controlling the touch-sensitive electronic device to execute the operation of the selected application.

8. The method according to claim 7, wherein the external keypad comprises a plurality of keys and sensors to detect which key is pressed.

9. The method according to claim 8, wherein the keys comprise numerical keys, alphabetical keys, directional keys, and functional keys.

10. The method according to claim 9, wherein the directional keys comprises an upward-arrow key, a downward-arrow key, a leftward-arrow key, and a rightward-arrow key, and the functional keys comprise an accelerator key and a volume control key.

11. The method according to claim 7, wherein the external keypad is connected to the touch-sensitive electronic device through a universal serial bus (USB) interface or a wireless connection including a WIFI connection and a Bluetooth connection.

12. The method according to claim 7, wherein the coordinate position of each key of the external keypad on the touch screen is set by establishing an X-Y coordinate system based on a width and length of the touch screen, and by defining the coordinate position for each key of the external keypad based on the X-Y coordinate system.

13. A non-transitory storage medium having stored thereon instructions that, when executed by at least one processor of a touch-sensitive electronic device, cause the processor to perform a method for controlling applications using an external keypad connected to the touch-sensitive electronic device, the method comprising:
initializing keys of the external keypad when the external keypad is connected to the touch-sensitive electronic device;
receiving a selection of an application to be controlled by the external keypad from one or more applications displayed on a touch screen of the touch-sensitive electronic device;
setting a coordinate position for each key of the external keypad on the touch screen, and associating the coordinate positions of the keys with operations of the selected application;
receiving a sensing signal from the keypad when a key of the external keypad is pressed, and determining which key is pressed according to the sensing signal;
determining a coordinate position of the pressed key on the touch screen, and determining an operation of the selected application according to the coordinate position of the pressed key; and
controlling the touch-sensitive electronic device to execute the operation of the selected application.

14. The storage medium according to claim 13, wherein the external keypad comprises a plurality of keys and sensors to detect which key is pressed.

15. The storage medium according to claim 14, wherein the keys comprise numerical keys, alphabetical keys, directional keys, and functional keys.

16. The storage medium according to claim 15, wherein the directional keys comprises an upward-arrow key, a downward-arrow key, a leftward-arrow key, and a rightward-arrow key, and the functional keys comprises an accelerator key and a volume control key.

17. The storage medium according to claim 13, wherein the external keypad is connected to the touch-sensitive electronic device through a universal serial bus (USB) interface or a wireless connection including a WIFI connection and a Bluetooth connection.

18. The storage medium according to claim 13, wherein the coordinate position of each keys of the external keypad on the touch screen is set by establishing an X-Y coordinate system based on a width and length of the touch screen, and by defining the coordinate position for each key of the keypad based on the X-Y coordinate system.
